(19) United States
(12) Patent Application Publication
(10) Pub. No.: US 2008/0313730 A1
(43) Pub. Date: Dec. 18, 2008

(54) EXTENSIBLE AUTHENTICATION MANAGEMENT

(75) Inventors: Sorin Iftimie, Issaquah, WA (US); Bruce P. Bequette, Lynnwood, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/763,657

(22) Filed: Jun. 15, 2007

(51) Int. Cl. G06F 21/20

(52) U.S. Cl. 726/17

(57) ABSTRACT

A system and method for controlling access to a resource permits an administrator to make changes to access policies at a server level without having to update client code unless and until such updated code is actually needed by a client. Customizable, plug-in gates are provided to permit administrators fine grained control over access policy definition. The most updated versions of corresponding gate clients used to display the gates are identified to client systems when an access request is made. The updated gate clients are downloaded if and when requested by a client system that has not already stored the updated gate clients locally. The user's responses to gate challenges are compared to responses presented by the user at registration. If the responses meet the access policy's threshold for accuracy, the user is permitted to access the resource.

### BACKGROUND

Authentication of users to control access to a resource (such as a computer system or network) is a significant challenge for system administrators. A single computer system, for example, may include different types of users with different levels of permissions to a variety of different resources within the system. Due to the variety of users and resources within a system, administrators may desire to use multiple authentication mechanisms to protect different resources.

Maintenance of multiple authentication mechanisms, however, can significantly burden an administrator and the system as a whole. For example, in a client-server environment, authentication mechanisms may require certain computer code to be resident on a client system. Often, changes to such client code are necessary, and many administrator systems use short messaging service (SMS) or other “push” technology to update client-side code. However, this requires that all client machines be updated every time such a change is made, regardless of whether such updates are needed by any users of the client systems. For large systems with many clients, this can be a significant resource drain that is made worse by increasing the number of applications (such as authentication mechanisms) that require client-side updates and maintenance. In addition, until updates are “pushed” to clients, client code may be outdated.

In addition, client system distinctions make the use of multiple authentication mechanisms more difficult. Client systems within the same network may run different operating systems, use different processor types, and display content in different languages. The differences among client machines make maintenance and updates of authentication systems more complicated. In order to simplify maintenance, this may lead to administrators to employ fewer and simpler authentication mechanisms to the detriment of system security and flexibility. Administrators may also choose to update client code infrequently (e.g., each night as a batch process) to limit the effect of such updates on system resources. This can cause updates made on a server to be out of synch with client code or cause an undesirable delay of making updates on both the server and the client.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Among other things, the claims recite a system and method for controlling access to a resource that permits an administrator to make changes to access policies at a server level without having to update client code unless and until such updated code is actually needed by a client. Administrators create access policies using gates. The most updated versions of corresponding gate clients used to display the gates are identified to client systems when an access request is made. The updated gate clients are downloaded if and when requested by a client system that has not already stored the updated gate clients locally. The user's responses to gate challenges are compared to responses presented by the user at registration. If the responses meet the access policy's threshold for accuracy, the user is permitted to access the resource.

One aspect relates to a method for determining whether to grant users access to a resource. Rather than pushing client updates, the method waits for a user to request access to a protected resource. When a request for access is received, a determination is made as to what access policy applies to the request. A first “gate” from the access policy is then provided. Also provided is a first identifier identifying a first gate client that corresponds to the first gate. If requested, the first gate client is also provided. A response from the first user is received, and if the response satisfies the applicable access policy, the request for access is granted.

Another aspect relates to a system for obtaining access to a resource, including a processor and a memory storing computer instructions to perform certain acts. A first request to access the resource is provided, and a first gate and first identifier, identifying a first gate client, are received. A determination is made whether the first gate client is stored locally. If not, the first gate client is requested, and the first gate client is received. The first gate is presented using the first gate client, and a response to the first gate is provided.

Another aspect relates to a computer readable medium, encoding instructions to perform certain steps to determine whether to grant users access to a resource, including receiving a first request from a first user to access the resource. The first request includes cultural information referencing a first client culture. A determination is made as to what access policy applies to the first request. A first gate included in the access policy is provided, as well as a first identifier, from a plurality of identifiers, identifying a first gate client, wherein the first gate client corresponds to the first gate and is adapted to the first client culture. At least a first response is received from the first user, and access is granted if the first response(s) satisfy the applicable access policy.

Other aspects of other embodiments are set forth in the following Detailed Description and Claims appended hereto.

### DESCRIPTION OF THE DRAWINGS

Reference will now be made to the accompanying drawings, which are not necessarily drawn to scale and may describe particular embodiments which are not intended to be limiting in scope, and wherein:

FIG. 1 illustrates an example of an authentication system;

FIG. 2 illustrates an example of a computing device;

FIG. 3 illustrates an example of a method for authentication registration;

FIG. 4 illustrates an example of a method for administering gates and access policies;

FIG. 5 illustrates another example of a method for administering gates and access policies and associating access policies with users and resources;

FIG. 6 illustrates an example of a method for determining whether to grant access to a resource;

FIGS. 7A and 7B illustrate another example of a method for determining whether to grant access to a resource; and

FIG. 8 illustrates an example of a method of obtaining access to a resource.

### DETAILED DESCRIPTION

Example embodiments will now be described more fully hereinafter with reference to the accompanying drawings. Like numbers refer to like elements throughout.

As used herein, the terms “module,” “component,” “service,” and “system” are intended to refer to a computer-related entity, either hardware, a combination of hardware and software, software, or software in execution. For example, a module can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more modules can reside within a process and/or thread of execution, and a module can be localized on one computer and/or distributed between two or more computers.

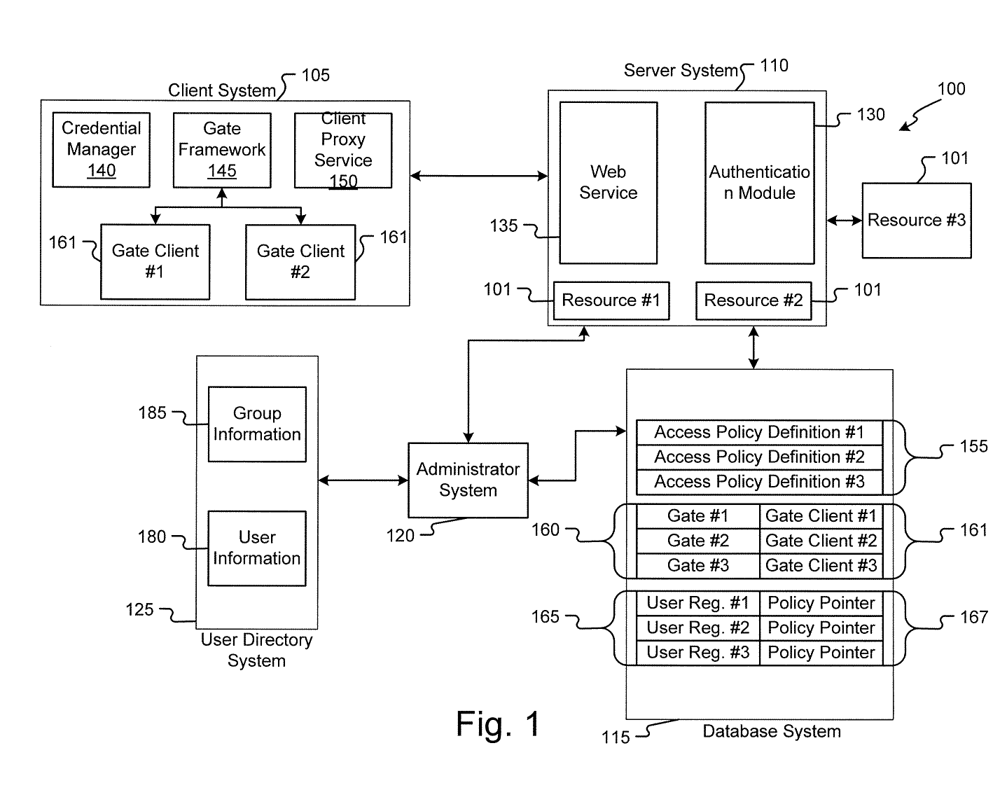

Referring now to FIG. 1, a system 100 for determining whether to allow users to access a resource is shown. In an embodiment, system 100 includes a resource 101, a client system 105, a server system 110, a database system 115, an administrator system 120, and a user directory system 125. A user may access a resource 101, for example via client system 105. The resource 101 may comprise, among other things, a network, file, data, computer, module, function, device, or any other entity. In embodiments, the resource 101 comprises a module that permits users to reset a credential that is used to access a protected system, network, file, server, etc. The credential may include a password, a smartcard pin, or other authentication mechanisms. Resource 101 may comprise or be implemented on server system 110 or may be separate from server system 110.

In embodiments, the client system 105 is connected to the server system 110 via communication media, such as the Internet, an intranet, an extranet, etc. Server system 110 is connected to user directory system 125, administrator system 120, and database system 115 via communication media. In some embodiments, one or more of the resource 101, client system 105, server system 110, database system 115, user directory system 125, and administrator system 120 may comprise a single computing device or may comprise or be implemented on separate computing devices.

Server system 110 includes an authentication module 130. In embodiments, server system 110 also includes a web service 135 to communicate with client system 105 over a network, such as the Internet. Client system 105 includes a credential manager module 140, a gate framework module 145, and a client proxy service 150. Gate framework module 145 makes calls to locally stored gate clients 161 as described hereinafter.

User directory system 125 includes user and group information that can be used by administrator system 120 as discussed herein. Moreover, in embodiments, the user directory system 125 can be used as an alternative or threshold authentication system. For example, if resource 101 comprises a credential-reset module (a module that permits a user to reset a credential used to access a network, file, computer, system, etc.), user directory system 125 may be used to authenticate the user to such network, file, computer, system, etc. In other embodiments, the resource 101 may comprise a module running on server system 110, and the user directory system 125 could be used to authenticate the user's access to server system 110, while the user's access to resource 101 is controlled by authentication module 130. User directory system 125 may comprise, for example, a server computer running Active Directory, a user directory system available from Microsoft Corporation of Redmond, Wash. In embodiments, user directory system 125 checks the user name and credential (e.g., password) provided by the user with the user name and credential stored in user directory system 125. If there is a match, the user is permitted access; otherwise, the user is denied access.

In embodiments, a user may request access to resource 101 through client system 105, such as by interacting with client system 105 through a user interface (UI) presented by credential manager module 140. The UI may be provided to the credential manager module by gate framework 145. In embodiments, a user sends a message to server system 110 through gate framework 145, client proxy service 150 and web service 135 requesting access to a resource 101. The request may include user information (e.g., a user name or a user identification number), resource information (e.g., identification of the resource 101 to which access is requested), and client cultural information. Client cultural information may include, in embodiments, one or more of: the operating system and processor type employed by client system 105, as well as the language (e.g., English, German, French, etc.) in which the user desires to interact with client system 105.

Authentication module 130 uses the user information and/or resource information to check the database system 115 and determine: (a) whether the user has previously registered for access to the requested resource; and (b) the access policy that applies to the user's request. Access policies may be user-specific, resource-specific, or both. For example, a single access policy may apply to a user's access to any resource 101. Alternatively, a single access policy may apply to a particular resource for all users of that resource. In other embodiments, the access policy that applies to a resource may be dependent on both the resource being accessed and the user requesting access. In addition, in embodiments, system 100 could be used to provide elevated access within a network. For instance, a user could log onto server system 110 via client system 105 after being authenticated by user directory system 125 (e.g., via a user name and password). Authentication module 130 could then be used to protect resources within the network via configurable gates 160 as discussed further below. For example, if a folder on a file server contained particularly sensitive information, users may be required to pass additional gates 160 (beyond the authentication of user directory system 125) to access that folder.

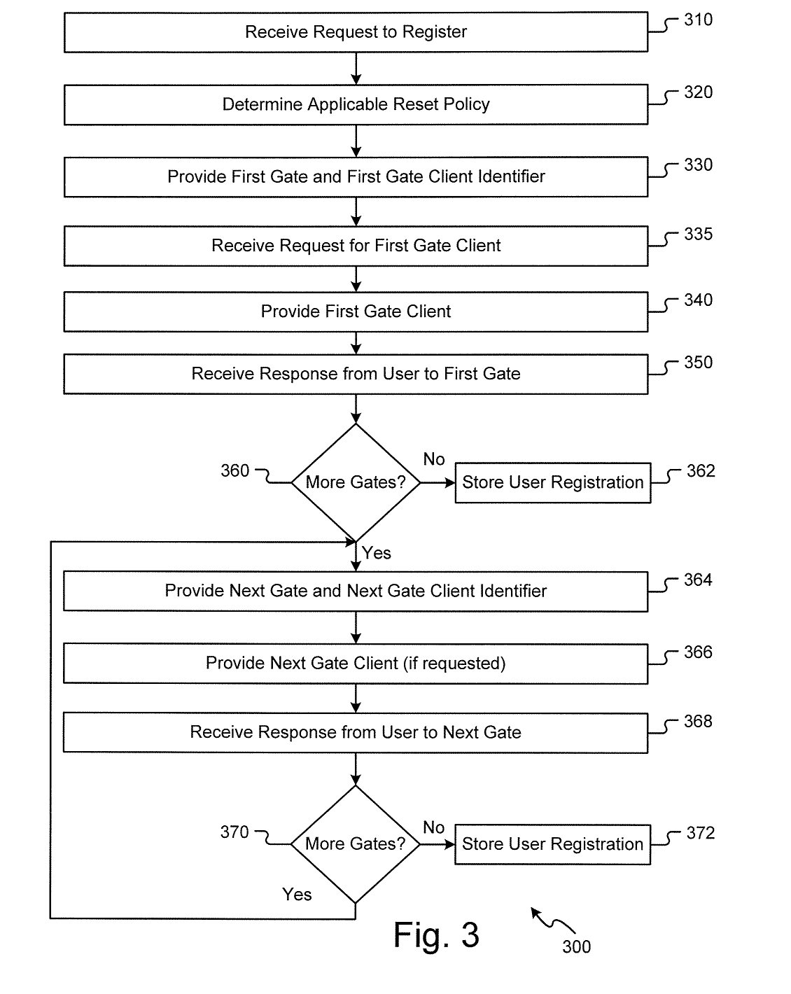

The determination of which access policy applies to the access request may be performed in a variety of ways. For example, a pointer 167 to the applicable access policy definition 155 that applies to the access request may be stored in, and accessed directly from, the database system 115. In FIG. 1, for example, the policy pointer 167 is stored with a user registration 165. User registrations 165 (as discussed in relation to FIG. 3) can include user information and resource information.

Alternatively, the authentication module 130 may access the user directory system 125 to determine whether the user is registered and the “group(s)” to which the user belongs. Groups are discussed further hereinafter. The authentication module 130 could then determine the applicable access policy based on logic or administrator-set rules contained within the authentication module 130. If the user has not registered using the applicable access policy, however, the user may receive an error message when attempting to access a resource 101. Other variations are possible and within the scope of the claimed embodiments.

In an embodiment, the authentication module 130 accesses the applicable access policy definition 155, which may be stored in database system 115. The access policy definition 155 identifies one or more gates 160 that the user must pass in order to be granted access to a resource 101. The gates 160 may also be stored in database system 115, and may comprise, in embodiments, dynamically linked libraries (DLLs). Different types of gates 160 may be provided. For example, a gate may include one or more questions to be answered by the user (e.g., “What is your mother's maiden name?”). A gate 160 may include a challenge for a user to insert his/her smartcard. Gate 160 types may also include other authentication types, such as a short-message-service (SMS) challenge, a grid-card challenge, or a biometric challenge. Gates 160 of the same type may also have different characteristics. For example, a first gate 160 may include three questions for the user to answer and a second gate 160 may include five different questions for a user to answer.

In addition, different access policy definitions 155 may identify the same gate(s) 160, but may require a different level of compliance to satisfy the policy. For example, a first policy may require the user to submit a response to a gate 160 that comprises five questions for the user. The first policy may be satisfied by a user answering four of the five questions correctly. A second policy, on the other hand, may require the user to respond to the same gate 160 but require all five questions to be answered correctly in order to satisfy the second policy.

Gates 160 may comprise DLLs that include all of the data associated with the challenges, such as the text of the questions to be asked of the user or instructions on how to comply with a challenge (e.g., “Please scan your fingerprint now.”). Gate clients 161, in embodiments, may comprise one or more separate DLL's that include the executables to display the data in gates 160, receive responses to the challenges posed by gates 160, and route the responses appropriately back to server system 110. Because the gates 160 and gate clients 161 may be implemented as a plug-in modules (such as DLL's) the system 100 is eXtensible. For example, third parties may choose to create new gates and gate clients that can be imported into database 115 and used by an administrator to create a new access policy. In addition, a single gate client may be used by more than one gate. For example, two different question-and-answer gates, in embodiments, may use the same gate client because the user-interface requirements of both gates may be identical even if the content of the gates is different.

In addition, gates 160 and gate clients 161 may include gate settings, which may comprise variables that can be customized by an administrator, such as the text of questions to be presented to the users, the language to be employed in presenting challenges to the users, etc. For example, a gate 160 may include the text of questions in several different languages, and a setting of gate client 161 may cause only a particular language to be displayed to the user. Gate settings may be accessed by administrator system 120 via APIs included in gates 160 and/or gate clients 161 or by other means.

In embodiments, a user registers with the authentication module 130 prior to attempting to access a resource 101. The client system 105 stores the gate clients 161 identified by the applicable access policy at the client system 105 when the user registers with the authentication module 130 (discussed below). However, users may register on one client system 105 and then attempt to access a resource 101 on a different client system that has not yet stored the necessary gate client 161. In addition, updates and changes could be made to gate clients 161 between the time the user registers and when the user attempts to access a resource 101. In other embodiments, the culture of client system 105 may change between the time of user registration and when the user seeks access to a resource 101 so that the gate client 161 previously stored during registration is no longer useable with client system 105.

Accordingly, in embodiments, when the user requests access to a resource 101, the authentication module 130 sends the gate 160 from database system 115 and an identifier of the corresponding gate client 161 that matches the current culture of the client system 105. Gate framework 145 checks whether the gate client 161 identified by the identifier is stored locally (such as through a previous registration or authentication).

In embodiments, the identifier is a hash valued, and the gate framework 145 ensures that the client system 105 has stored the correct (and updated) gate clients 161 by checking hash values associated with the gate clients 161 stored on the client system 105 against hash values provided by the server system 110 from database system 115. In embodiments, the hash value is created through a one-way hash (such as an MD5 hash) of the gate client 161. If the identified gate client is locally stored, gate framework 145 uses the locally stored, executable gate client 161 to display the gate 160 through a UI at credential manager 140. Otherwise, the client system 105 requests that the server system 110 send the identified gate client 161. Once received, the gate client 161 is used to display gate 160 and is stored locally for future use.

The client system's 105 request for the gate client 161 may involve several requests. A gate client 161 may be implemented in several different DLL's that call, or are dependent upon, one another. In embodiments, the gate framework 145 of client system 105 makes an initial request to server system 110 for a first gate client file. The client system 105 may then query the server system 110 whether there are any more files that comprise the gate client 161. For example, developers of gates 160 and gate clients 161 may wish to leverage functions already available in other gate client files rather than having to recreate those functions in each gate client 161. By querying the server system 110 for gate-client dependencies until all dependencies have been received, the gate framework 145 permits greater extensibility of existing gate client code. In embodiments, the gate framework 145 checks an identifier from the server system 110 for each gate client file to ensure that only the gate client files not already locally stored by the client system are downloaded. Downloading can take any form, including real-time streaming.

In embodiments, gates 160 are not stored at client system 105 to make it more difficult for unauthorized users to predict gate challenges and accomplish an unauthorized access. Rather, gates 160 are held in memory (such as RAM) at client system 105 for only long enough to display to the user and receive a user response to the gates 160. The memory may then be reallocated

In embodiments, gate framework module 145 calls gate client 161. Gate 160 is then presented through a UI defined by the gate client 161. The gate client 161 UI can be presented by the credential manager 140. The user responds to the challenges of the gate(s) 160 presented. In embodiments, a first gate 160 is presented and must be satisfied according to the applicable access policy before a user is presented with a second gate 160. In other embodiments, challenges (such as questions) within a gate must be responded to by the user before the user is presented with the next challenge within the gate 160. These measures make hacking and unauthorized access to resources more difficult.

Rather than pushing updates to gate clients 161 to all client systems 105 (other client systems 105, not pictured, may be in communication with and/or within the same security domain as server system 110), the system illustrated in FIG. 1 provides updated gate clients only upon request. By providing a system in which gate clients 161 are downloaded only if and when needed by client system 105, system resources are saved and administration of gates is simplified. In embodiments, only the gate framework module 145, which is likely to needs updating less frequently than gate clients 161, is present on each client system 105 prior to a specific access request.

Client system 105 submits a response (which may comprise a series of responses to individual challenges or different gates) to the server system 110. In embodiments, the user's inputted response is received from the user and provided to server system 110 by gate framework 145 using logic in gate client 161. Receiving user responses may require interaction with peripheral devices such as keyboards, biometric scanners, smartcard readers, etc. In embodiments, instructions to control such interactions are included in the gate framework 145 and/or in gate clients 161. The response may be included in a security token, subjected to a one-way hash function, or otherwise encrypted, particularly if the response includes personal information in response to a question that is part of a gate (e.g., social security number, date of birth, etc.).

Server system 110 verifies that the response satisfies the applicable access policy (e.g., by answering correctly at least a minimum number of questions, or satisfying particular challenges, within each gate). Verification of responses may be accomplished, in embodiments, by comparing the response(s) to user registration 165, which may be stored within the database system 115 and indexed to the user. For example, upon registration, the user may be prompted for answers to the five questions that make up a first gate 160. The user's responses are stored as user registration 165, and may be subject to a one-way hash to protect the content of the responses. The hash function can be completed by the gate framework 145 prior to providing the user registration to the server system 110 or database system 115. When the user responds to the challenges within the first gate, authentication module 130 can compare the responses to the user registration 165. User registration 165, in embodiments, is stored with or indexed to a pointer 167 to the applicable policy definition 155 in database 115. Again, the responses may be subjected to the same one-way hash function used by gate framework 145 during registration. Server system 110 can compare the hashed response(s) to the previously hashed user registration 165 to determine if the applicable access policy has been satisfied. Registration is discussed further in relation to FIG. 3.

If the applicable access policy is satisfied, the user is permitted access to the resource 101. This can be accomplished, in embodiments, by sending a message from authentication module 130 to resource 101. In an embodiment where the resource 101 is a credential reset module, this can be accomplished by prompting the user for a new credential through credential manager 140 and saving the user's new credential information in user directory system 125. This is further described in U.S. patent application Ser. No. ______, entitled “Self-Service Credential Management,” the specification of which is assigned to the same assignee and is incorporated by reference as if fully set forth herein.

In embodiments, a system administrator is permitted to create and customize gates and access policies through administrator system 120. Administrator system 120, in embodiments, has access to user directory system 125, which may include both user information 180 and group information 185. User information comprises user identifying information, such as a user name or user identification number. Group information 185 indicates the group(s) of which the users are members. For example, the accounting department of a corporation could be made members of the “accounting” group. The accounting group, then, is provided via user directory system 125 with certain permissions to information, applications, and utilities that may be different from permissions for other groups.

In embodiments, the system administrator is presented with a UI through administrator system 120 that permits the administrator to: (a) create new access policies; (b) modify or delete existing access policies; (c) import new gates; (d) assign and reassign access policies to resources 101, user groups or individual users; and (e) delete user registrations 165 if previously applicable access policies are modified or deleted. For example, an administrator may create a new access policy choosing a combination of gates. If necessary or desirable, an administrator may import or create a new gate in addition to the gates 160 already defined in database 115. The administrator can then use gate settings to customize the characteristics of the gates and set pass/fail criteria for the gates to create a new access policy definition 155 to be stored in database 115. The administrator can choose to apply or associate the new access policy to particular resources, to individual users, and/or to user groups, for example, the groups defined in user directory system 125.

For example, the administrator may store a list of users or groups in authentication module 130 or database 115 along with a corresponding list of access policies applicable to each user or group. When a user registers for authentication, authentication module 130, in embodiments, checks the user information and resource information from the user against the list of corresponding access policies. In other embodiments, the authentication module 130 checks a user directory service 125 to determine the groups to which the user belongs and checks those groups against the list of corresponding access policies. Other systems and methods of associating or applying access policies to users or groups are possible and within the scope of the claims. If the new access policy is to replace an existing access policy, the administrator may choose to delete all of the user registrations 165 for users to which the new access policy applies. In these embodiments, the users may be prompted or required to re-register based on the new access policy.

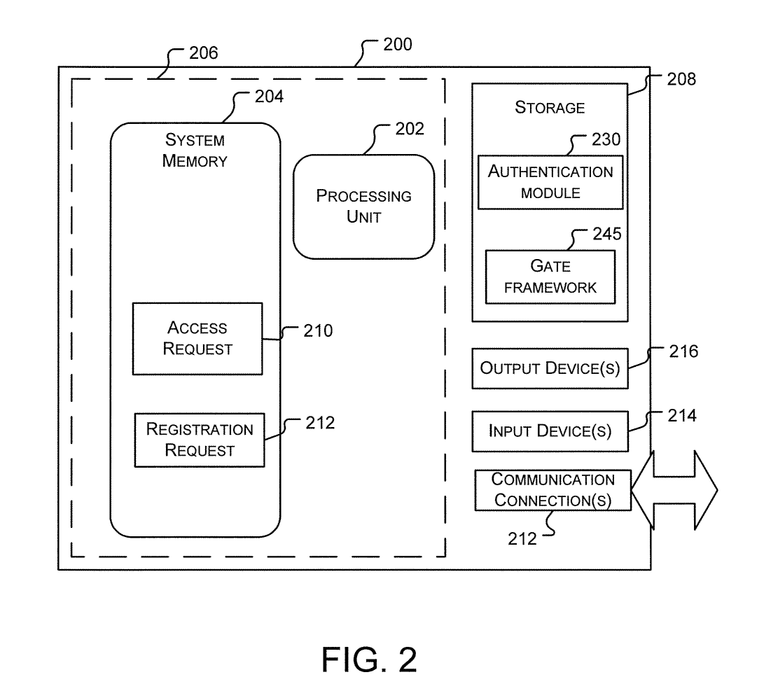

FIG. 2 illustrates a general computing device 200, which can be used to implement the embodiments described herein. The computing device 200 is only one example of a computing environment and is not intended to suggest any limitation as to the scope of use or functionality of the computer and network architectures. Neither should the computing device 200 be interpreted as having any dependency or requirement relating to any one or combination of components illustrated in the example computing device 200. In embodiments, computing device 200 may be used, for example, as a client system 205 or server system 210 as described above with respect to FIG. 1.

In its most basic configuration, computing device 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. System memory 204 stores applications that are executing on computing device 200. In addition to applications, memory 204 may also store information being used in operations being performed by computing device 200, such as an access request 210 and/or a registration request 212, as described below with respect to FIGS. 3-7.

Computing device 200 may also have additional features/functionality. For example, computing device 200 may also include additional storage 208 (removable and/or non-removable) including, but not limited to, magnetic or optical disks or tape. Such additional storage is illustrated in FIG. 2 by storage 208. Computer storage media includes volatile and nonvolatile, removable and non-removable media implemented in any method or technology for storage of information such as computer readable instructions, data structures, program modules or other data. Memory 204 and storage 208 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 200. Any such computer storage media may be part of computing device 200.

As those with skill in the art will appreciate, storage 208 may store a variety of information. Among other types of information, storage 208 may store a authentication module 230 (e.g., in the case of a server system) or gate framework 245 (e.g., in the case of a client system).

Computing device 200 may also contain communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Computing device 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

FIG. 3 is a flow diagram demonstrating an embodiment of a registration method 300. The user requests 310 to register for resource authentication. This can be initiated by the user through a UI presented to the user, which the user can select. Alternatively, the user's request can be a response to an email or other communication asking the user to register. For example, an administrator may require all new users to register for resource authentication upon first accessing a corporate network. In embodiments, the user's request will include information identifying the user and identifying the resource to which the user desires to register for authentication. As previously described, the user's request may also include cultural information relating the culture of the client system the user employs to register for authentication.

For the purposes of description, and without limitation, this description of FIG. 3 will assume that the protected resource is a credential-reset module or function. More particularly, the user would like the ability to reset the user's credential (e.g., password) to a protected computer network without having to contact an administrator (self-service credential reset). If the user is granted access to the resource (credential-reset module or function), the user is permitted to reset the user's credential (e.g., pick another password) to be used thereafter to log onto the protected computer network. In order to use the resource (e.g., credential-reset module), the user must register after logging onto the protected computer network. Other examples of resources include, without limitation: a file, server, computer, network, or other system.

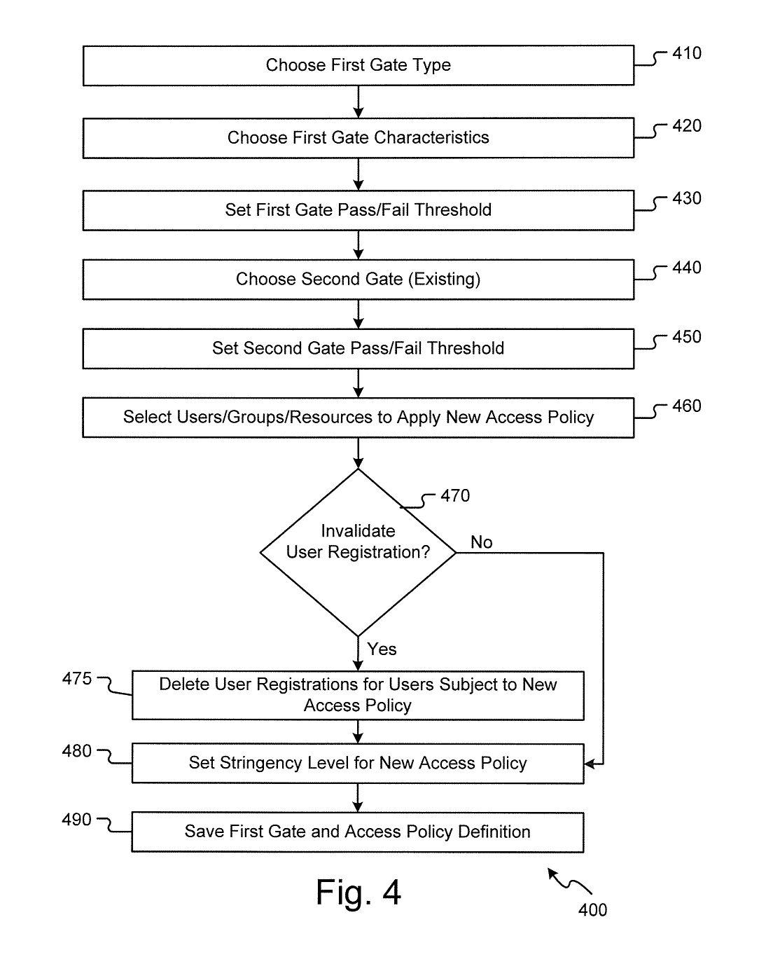

The method proceeds to step 320, wherein a determination is made as to what access policy applies to the user's request. As discussed further in relation to FIG. 4, an administrator may associate a resource to an applicable access policy, regardless of the user making the request. With regard to other resources, it may be advantageous to associate a user to an applicable access policy according to what group(s) the user belongs to within the corporate network. For example, where the resource is a credential reset module or function, an administrator may decide, previous to the user's request to register, to apply a first access policy to all members of the accounting group, while a second access policy applies to all members of the shipping group. The first access policy may be made more stringent (e.g., more questions, higher threshold of right answers to satisfy the policy, more gates, etc.) because the accounting department will generally have greater access to sensitive information on the network than members of the shipping department. In this instance, the administrator may create a rule that any member of a particular group is subject to a particular policy. Alternatively, an administrator may choose to delineate on a per-user basis what access policy applies to that user, and the policy that applies to that individual user may be specified in a file associated with the user's identity (such as the user's name or user identification number).

Users may be members of more than one group within the corporate network (e.g., a user could be a member of both the accounting and sales groups). In this case, an administrator may, in embodiments, set a hierarchy of the multiple access policies that have been defined. The hierarchy may rank the policies according to stringency (e.g., difficulty to satisfy). The administrator may then choose to set a rule that if the user is a member of more than one group, only the most stringent access policy applying to one of the groups of which the user is a member will apply to the user. In this manner, the user will not be required to satisfy the access policy that applies to every group of which the user is a member, which could otherwise be overly burdensome.

In embodiments, the determination step 320 may involve checking the user information and resource information supplied by the user in the request against a list created by an administrator that associates users and resources to particular access policies. It may also comprises (a) checking the user information against a user directory to determine groups to which the user belongs; and (b) if the user belongs to more than one group, determining the most stringent access policy that has been associated with the resource and one of those groups of which the user is a member.

Next, the method proceeds to step 330. In the embodiment shown, a first gate client specified by the applicable access policy for the user is provided to the client. In addition, a first gate client identifier is provided to the clients. In embodiments, the first gate client identifier identifies a gate client that (a) corresponds to the first gate; and (b) matches any client cultural information included in the registration request. For example, the request to register may include information relating to the operating system, processor type, and language preference of the client system that the user is employing to complete the registration. A server system may have access to multiple gate clients that correspond to the first gate. For instance, if the first gate is a question-and-answer gate, there may be one gate client that is programmed to display questions and is adapted to a Windows Vista operating system, an x64 processor architecture, and a display language of German. A separate gate client that is programmed to display questions and may be adapted to a Windows XP operating system, an x86 processor architecture, and a display language of English. These two different gate clients, in embodiments, may be tagged with different identifiers so that the appropriate gate client to match the requesting client's culture can be identified and employed. The identifiers, in embodiments, may be hash values of the gate clients.

In embodiments, the client system receives the first gate and first gate client identifier and checks its local storage to determine whether it already has the first gate client. The client system, in embodiments, attempts to match the first gate client identifier to the list of identifiers corresponding to gate clients that are locally stored on the client system. If the client system does not have the first gate client in local storage, it may request the first gate client from the server system. By downloading the first gate client to the client system only when requested, fewer overall system downloads are required. Also, client systems are always up to date because they can request what they need from a server system when they need it (rather than relying on periodic batch downloads to all client systems).

At step 335, a request for the first gate client is received. The first gate client is then provided 340. In embodiments, a client system requests a gate client that it does not already have in local storage and the server system provides the first gate client to the client system. The first gate client can then be stored locally for future use.

At step 350, a response is received from the user to the first gate. For example, the user may be presented with the first gate (e.g., a series of questions—mother's maiden name, high school attended, etc.). If the gate type is a smartcard gate, the user may be asked to scan the user's smartcard. The user may then respond with answers to the challenges (e.g., questions) presented within the first gate, and the users response is received, such as by a server system. The response could be a single response including answers to all the questions or challenges of the first gate, or it could be a series of responses to iterative challenges of the first gate presented to the user.

A determination is made 360 whether any more gates are required by the applicable access policy. If not, the user registration information included in the response is stored and the process ends 362. If more gates are identified by the applicable access policy, the next gate client and next gate client identifier for the applicable access policy are provided 364. Alternatively, all gates and gate clients specified in the applicable access policy can be provided at the same time. The method proceeds to step 366, wherein the next gate client is provided, if requested (e.g., if a client system that receives the next gate client identifier does not have the next gate client in local storage). A response is received 368 from the user, and a determination is made 370 whether any more gates are specified by the applicable access policy. If not, the user registration information included in the response(s) is stored and the process ends 372. If so, the method loops back to step 364 until all gates specified by the applicable access policy have been provided and responded to by the user.

User registrations, in embodiments, may be policy specific (i.e., a user must register separately for every access policy that controls access for a resource employed by the user). In other embodiments, a user may register responses to all available gates. In this manner, the user may need to register less often if, for example, an administrator decides to mix and match existing gates for which the user has already registered responses. Responses to individual gates given during registration could then be stored separately per gate for comparison to responses to gate challenges during access attempts. For example, if a user registers for an access policy that includes Gate 1, Gate 2, and Gate 3, the user would not need to re-register in this embodiment for an access policy that comprised only Gate 1 and Gate 3.

FIG. 4 illustrates an embodiment of a method for administering gates and access policies. Access policies may be created or changed by an administrator. In some embodiments, the administrator is presented with a UI listing all of the available gates for inclusion in an access policy. The administrator may also create or import additional gates for inclusion into an access policy. A first gate type is chosen 410 to include in access policy. For example, the administrator may choose a first gate type that is a smartcard gate or a question-and-answer gate. The characteristics of the first gate are then chosen 420. For example, if the first gate is a question-and-answer gate, the characteristics may include the number of questions and the text of the questions. This can be accomplished by configuring gate settings included in the first gate. The pass/fail threshold for the first gate is then set 430. For example, if the administrator has chosen to include a first gate that consists of ten questions, the administrator may decide that seven right answers from the ten questions are enough to pass the first gate. For other access policies, the administrator may decide that all ten must be answered correctly to pass the gate. Accordingly, even if two access policies use the same gate types and gate characteristics, the policies can differ based on the pass/fail threshold applied by the administrator for that access policy. Alternatively, the pass/fail threshold could be included as part of the gate.

A second gate may be chosen 440 to add to the new access policy. In this embodiment, the second gate already has defined characteristics. The second gate could be an existing gate that the administrator is choosing to reuse for purposes of this new access policy. The administrator may also choose to download a third-party's predefined gate and use it in the new policy. For example, a third party may have created an authentication mechanism that can be downloaded as a DLL and used as a gate that is part of an access policy.

The pass/fail threshold for the second gate is then set 450. If the second gate is a smartcard gate, for example, the pass/fail threshold may comprise simply a yes/no decision whether the user presents the same smartcard when requesting credential reset as the user presents during registration.

In the embodiment shown, the access policy comprises only the first and second gates. The new access policy is then applied 460 to users or groups of users. This can be accomplished in a variety of ways. For example, if the new access policy was created to accommodate a new group of users, the new group of users may be prompted (e.g., by email or at next sign-on) to register pursuant to the new access policy.

If the new policy is applied to an existing group of users or resources, a determination can be made 470 whether the user registrations for the users in that group should be deleted. For example, if the new access policy is significantly different or more stringent from the old access policy that applied to those users or resources, a determination may be made to delete 475 the old user registrations that were based on the old access policy. This would require those users to re-register based on the new access policy. Otherwise the user registrations under the old access policy are unaffected and only new users added to the affected group are required to register according to the new access policy.

In embodiments, a stringency level for the new access policy may be set 480. As discussed, if a user is a member of more than one group, the applicable access policy for the requested resource may be the policy applying to the user that is the most stringent. By setting the stringency level of each new access policy, an administrator can create a hierarchy of access policies that can be used to apply only the most stringent policy that is associated with a group to which the user belongs. The method then proceeds to step 490 where the first gate and the definition of the access policy are stored. To the extent the second gate was, in this example, an existing and previously stored gate, the second gate need not be stored again.

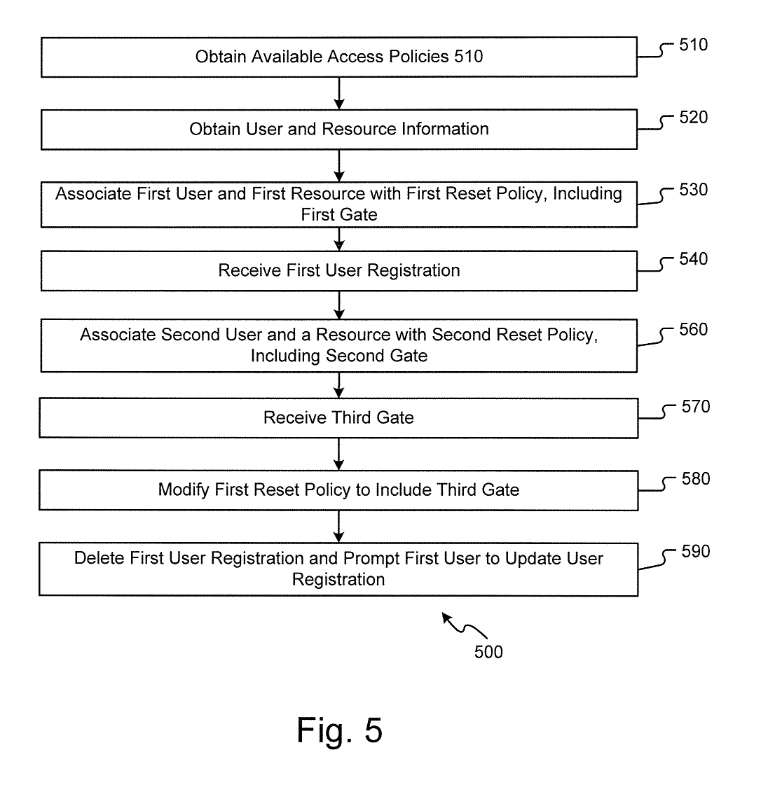

FIG. 5 illustrates another method 500 for administering gates and access policies and associating access policies with users. Available access policies are obtained 510. In embodiments, access policy definitions are stored in a database, and an administrator may read existing access policy definitions through a UI to determine whether to apply an existing access policy to a resource, a user or group of users. Obtaining available access policies includes, without limitation, downloading or reading access policy definitions from a database or other computer storage media. The method proceeds to step 520, when first user information is obtained. In embodiments, user information may comprise user identifying information, such as user names or user identification numbers. User information may also comprise information identifying groups to which the users belong. User information may also include information identifying permissions that users are granted within a resource. User information may be obtained, in embodiments, from a user directory system, a database, or other storage media. Resource information may include resource identifiers (such as network addresses) relating to resources to which access is being controlled by the present system and method.

At step 530 a first user and first resource are associated with a first access policy, which may include a first gate. In embodiments where the same access policy is applied to all users for a particular resource, only the first resource need by associated with the first access policy. In other embodiments, however, the access policy may be different depending upon the user. As discussed, the association of a user to an access policy can be accomplished in a variety of ways. For example, the user identification number of the first user can be indexed to, and/or stored with, a pointer to the first access policy (or first access policy definition) in a database or other computer storage media. In other embodiments, an identifier indicating a group of which the first user is a member is indexed to, and/or stored with, a pointer to the first access policy.

At step 540, a first user registration is received. The first user may register in the manner described elsewhere herein. In embodiments, the first user registration includes responses to gates included in the first access policy. The first user registration may also include the first user information and first resource information so that the first user registration can be easily accessed when the first user later attempts to access the first resource.

At step 550, a second user and a resource are associated 560 with a second access policy in the manner discussed. In embodiments, the resource may be the first resource or a different resource. The second access policy, in embodiments, is different from the first access policy and includes a second gate. An administrator may choose, for example, based on user information to apply a second access policy to the second user that is less stringent than the first access policy, even if both users are registering for access to the same resource. For example, if the resource is a self-service credential reset module that permits the users to reset a credential protecting a corporate network, the first user may be required to submit to a stricter access policy than the second user if the first user's permissions within the corporate network are more extensive (and resetting the first user's credential represents a bigger security risk).

At step 570, a third gate is received. The third gate may comprise a DLL or other computer file(s) from a third-party vendor that is stored in, or accessed from, a database or received from a different system. The third gate can be used, in embodiments, to modify 580 the first access policy. For example, the first access policy definition may be accessed by an administrator, modified to include both the first gate and the third gate, and stored in a database or other storage media.

If the first access policy is modified significantly (e.g., such that the first access policy is now more stringent than before modification), the first user registration may be deleted 590 and the first user may be prompted to update the first user's registration. For example, if the third gate is added to the first access policy, the administrator may decide that all users who previously registered using the first access policy must now reregister because previous registrations are no longer valid. This can be accomplished, in embodiments, by searching a database for user registrations associated with the first access policy and having a time stamp prior to the modification of the first access policy. The first user (and other users subject to the former first access policy) could then be required upon login to reregister using the modified first access policy.

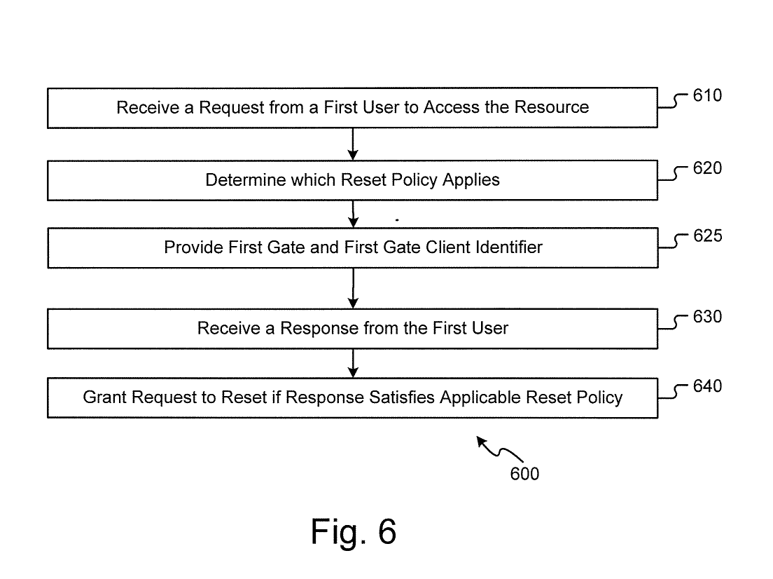

FIG. 6 illustrates a simple embodiment of a method 600 to determine whether to grant a request to access a resource. A first request is received 610 from a first user to access a resource. It is determined 620 which access policy applies to the first request. A first gate and first gate client identifier are provided 625. A response is received 630 from the first user. The request to access the resource is granted 640 if the response from the first user satisfies the applicable access policy.

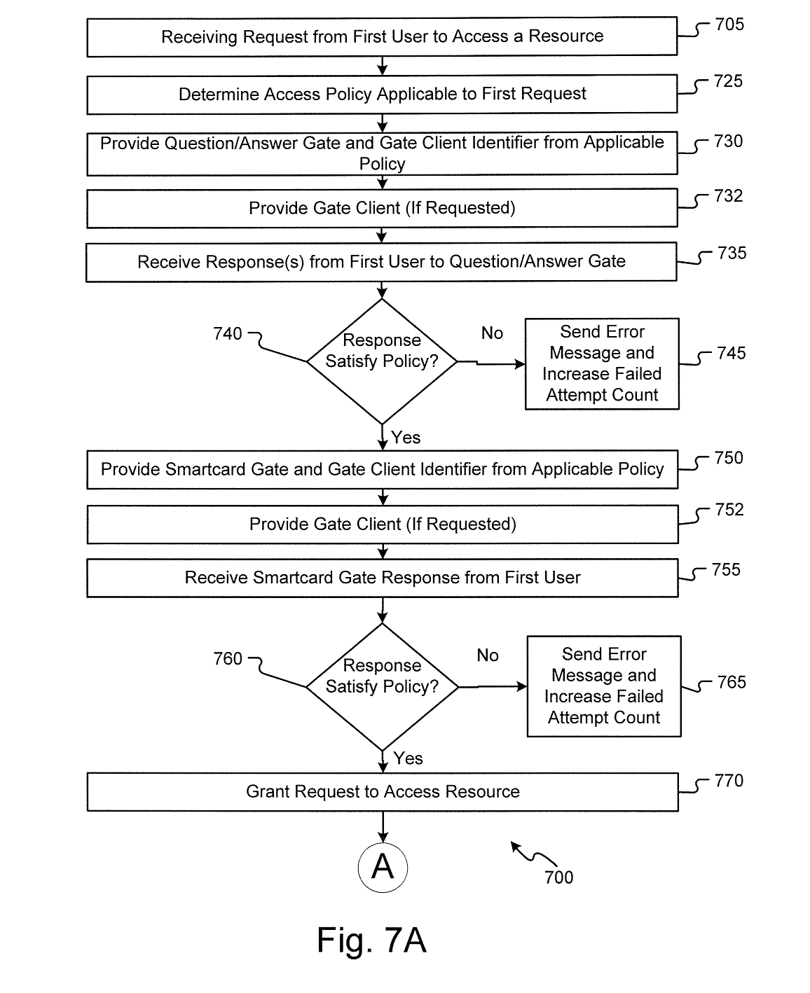

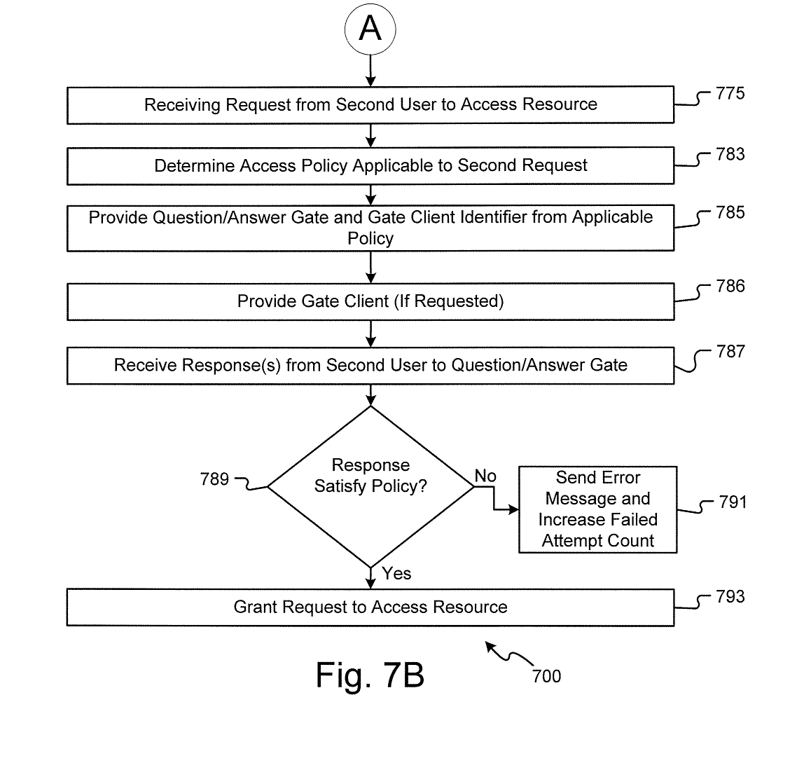

FIGS. 7A and 7B illustrate another embodiment of a method 700 for determining whether to grant a request to access a resource. A first request is received 705 from a first user to access a resource. A determination is made 725 as to which access policy is applicable to the first request. In embodiments, the determination is made 725 by mapping first user information and resource information received from the user as part of the request 705 to the applicable access policy. For example, if the user registered for access to a resource (such as a self-service credential reset module) pursuant to a first access policy chosen by an administrator, the user's information (e.g., user name) and resource information (e.g., resource identifier) may be indexed to the user registration and the applicable access policy definition. Determining step 725, in this embodiment, may comprise mapping the user information and resource information to the applicable access policy (e.g., by accessing the access policy definition indexed to the user information and resource information in a database or other storage media). In embodiments, a first user may have previously registered for different access policies that apply to different resources, so the combination of the user information and resource information may be needed to determine the applicable access policy. In this example, the applicable access policy comprises a first question-and-answer gate and a second smartcard gate.

The method proceeds to step 730 where the question-and-answer gate and a gate client identifier are provided. For example, the first request may contain cultural information identifying the culture (e.g., operating system, processor type, etc.) of a client system employed by the first user. In such embodiments, this step 730 may involve selecting a gate client identifier that corresponds to a gate client adapted to the culture identified in the first request.

In embodiments, a client system receiving the gate client identifier may search to determine whether the identified gate client is already resident within the storage associated with the client system. If not, a request may be received asking for the gate client. If requested, the gate client corresponding to the gate client identifier is provided 732.

A response to the question-and-answer gate is received 735. A determination is then made 740 whether the response satisfies the applicable access policy (i.e., validating the response). For example, the applicable access policy may require that 4 of 5 questions included in the question-and-answer gate match the answers provided by the first user during his registration. If the response does not satisfy the applicable access policy, the first user is sent 745 an error message and the failed-attempt count is increased by one. The failed-attempt count can be used to lock out the first user from further attempts to access the resource if the failed-attempt count reaches a predetermined threshold.

If the response to the first gate satisfies the applicable access policy, the method proceeds to step 750, where the smartcard gate and a corresponding gate client are sent to the first user. If the first user requests the gate client, it is provided 752. A response to the smartcard gate is then received 755 from the first user. For example, the first user may swipe his smartcard at a smartcard reader that is included in a client system. A determination is then made 760 whether the smartcard response from the first user satisfies the applicable access policy. In embodiments, this can be accomplished by forwarding the results of the user's smartcard scan to the certificate server the user identified upon registration. The certificate server then indicates whether the smartcard is valid. If not, the first user is sent 765 an error message and the failed-attempt count is increased by one. If the smartcard response from the first user satisfies the applicable policy, the first user's request for access to the resource is granted 770.

The method then proceeds to FIG. 7B, wherein a second request from second user to access a resource is received 775. A determination is made 783 as to which access policy is applicable the second request. In this example, the applicable access policy comprises only a question-and-answer gate with a different number of questions and different content of questions from the question-and-answer gate presented to the first user. In embodiments, the second user may be attempting to access the same resource as the first user, but an administrator has made access user-dependent, so the second user's applicable access policy is different from the first user's.

The method proceeds to step 785 where the question-and-answer gate and gate client identifier are provided to the second user. Again, the gate client is provided 786, if requested, such as by a client system that does not have the gate client in local storage. A response to the question-and-answer gate is received 787. A determination is then made 789 whether the response satisfies the applicable access policy. For example, the applicable access policy may require that 3 of 4 questions included in the question-and-answer gate match the answers provided by the second user during his registration. If the response does not satisfy the applicable access policy, the second user is sent 791 an error message and the failed-attempt count is increased by one. If the response to the first gate satisfies the applicable access policy, the method proceeds to step 793, where the first user's request to reset his password is granted.

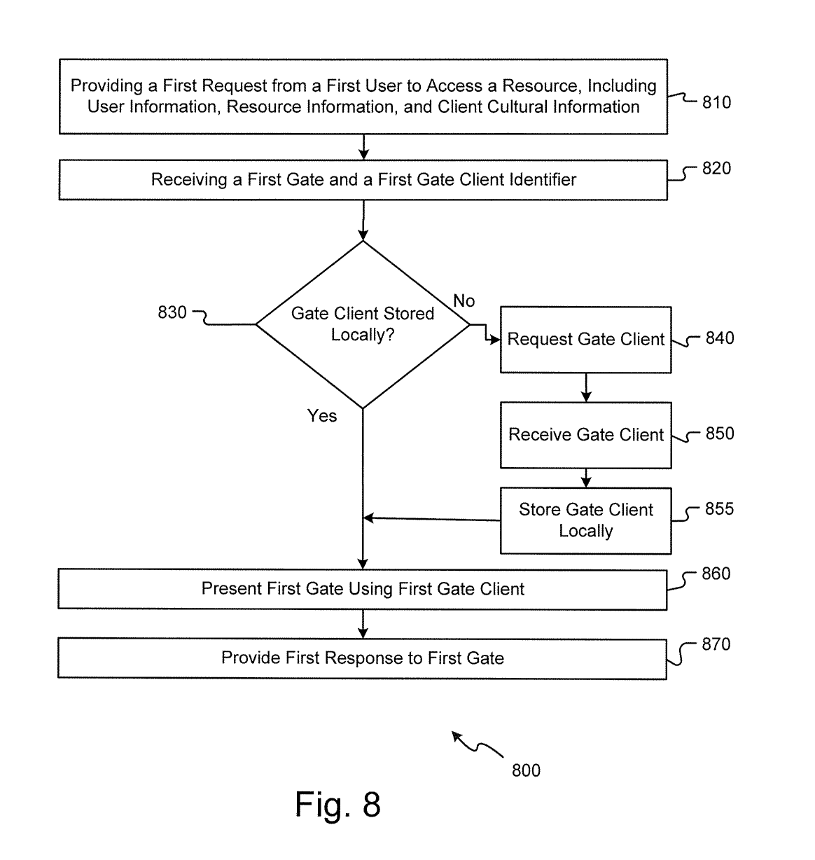

In embodiments, the method of FIGS. 7A and 7B may be implemented by a server system, such as server system 110 of FIG. 1. FIG. 8 illustrates a method for obtaining access to a resource. The method 800 of FIG. 8 may be implemented, in embodiments and without limitation, by a client system such as client system 105 in FIG. 1.

A first request is provided 810 from a first user to access a resource. The request, in embodiments, includes user information (e.g., a user identification number), resource information (e.g., a uniform resource locator), and client cultural information (e.g., operating system, processor type, preferred language of the client system being employed by the first user). The method proceeds to step 820, where a first gate and a first gate client identifier are received. In embodiments, the first gate comprises a data file includes the content of the challenge(s) of the first gate. For example, if the first gate may include the text of questions to be presented to the user in a question-and-answer challenge or instructions to complete a biometric challenge. The first gate client identifier identifies a gate client that corresponds to the first gate. The gate client, in embodiments, is a binary file that contains instructions to display the first gate. The first gate client identifier may, in embodiments, specifically identify a gate client that is adapted to the cultural information included in the first request such that the first gate can be properly displayed to the user (taking into account client cultural information such as the operating system, processor type, and preferred language of a client system being employed by the first user.

In embodiments, the first gate is temporarily stored in memory of a client system for display to the first user; the first gate is then deleted or the memory reallocated so that the first gate is no longer stored on the client system. Security may be improved if gates are not stored on the client system in a way that a user can access them outside of the authentication process.

A determination is made 830 whether the first gate client, identified by the first gate client identifier, is stored locally on the client system being employed by the first user. In embodiments, the first gate client identifier comprises a hash value, such as a hash of the first gate client. When a client system receives a gate client from a server system or database system, the gate client identifier is included, and the gate client, in embodiments, is stored in a local cache for later reuse. When a gate client identifier is then received, the local storage or cache is checked to determine whether the gate client matching the gate client identifier is already stored locally. If not, the gate client is requested 840 and received 850 from, for example, a server system. The first gate client is also stored locally 855 for future use. If the gate client was already locally stored, or after storing the first gate client, the method proceeds to step 860, where the first gate is presented to the first user using the first gate client. Alternatively, the first gate may be presented to the first user before the first gate client is stored.

In embodiments, a gate framework module calls the first gate client from local storage and causes execution of the instructions of the first gate client, which displays the data of the first gate in a user interface. The user interface, in embodiments, may be presented by a credential manager module (e.g., the user interface from the first gate client may be displayed within a user interface for credential management provided by the credential manager module).

The method proceeds to step 870, wherein a first response to the first gate is provided. For example, the gate framework may receive input from a user in response to the first gate and provide that response to a server system for comparison to a previous user registration. The client system employed by the user may include peripherals, such as a keyboard (to enter answers to question-and-answer challenges), a fingerprint, iris, or face-recognition scanner (for biometric challenges), etc. In embodiments, the gate framework module interacts with such peripherals to receive the input from the first client and provide the first response to the first gate.

Reference has been made throughout this specification to “one embodiment” or “an embodiment,” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that the claimed system and methods may be practiced without one or more of the specific details, or with other methods, resources, materials, etc. In other instances, well known structures, resources, or operations have not been shown or described in detail merely to avoid obscuring aspects of the claimed systems or methods.

While example embodiments and applications have been illustrated and described, it is to be understood that the claims are not limited to the precise configuration and resources described above. Various modifications, changes, and variations apparent to those skilled in the art may be made in the arrangement, operation, and details of the methods and systems disclosed herein without departing from the scope of the claims.

We claim:

1. A method for determining whether to grant users access a resource, comprising the steps of:
receiving a first request from a first user to access the resource;
determining an access policy that is applicable to the first request;
providing a first gate included in the applicable access policy;
providing a first identifier identifying a first gate client corresponding to the first gate;
receiving at least a first response from the first user; and
granting the first request if the at least first response satisfies the applicable access policy.

2. The method of claim 1, further comprising the steps of:
receiving a request for the first gate client; and
providing the first gate client.

3. The method of claim 1, wherein the first request includes first user information and wherein the determining step comprises determining an access policy that is applicable to the request based at least upon the first user information.

4. The method of claim 1, wherein the first request includes first user information and resource information and wherein the determining step comprises determining an access policy that is applicable to the first request based at least upon the first user information and the resource information.

5. The method of claim 1, wherein the first identifier comprises a hash value.

6. The method of claim 1, wherein:
the first request includes client cultural information referencing a first client culture;
the step of providing a first identifier comprises providing the first identifier from a plurality of identifiers; and
the first identifier identifies a first gate client adapted the first client culture.

7. The method of claim 1, further comprising:
validating the first response;
providing, after validation of the first response, a second gate included in the applicable access policy; and
receiving a response to the second gate.

8. The method of claim 1, further comprising:
receiving a second request from a second user to access the resource;
determining an access policy that is applicable to the second request;
providing a second gate included in the applicable access policy;
providing a second identifier identifying a second gate client corresponding to the second gate;
receiving a second response from the second user; and
granting the second request if the response satisfies the applicable access policy, wherein the access policy applicable to the second request is different from the access policy applicable to the first request.

9. The method of claim 1, wherein the resource is a module that permits the first user to reset a credential.

10. The method of claim 1, wherein the resource is a computer system.

11. A system for obtaining access to a resource, comprising:
a processing unit; and
a memory coupled with and readable by the processing unit and having stored therein instructions which, when executed by the processing unit, cause a gate framework module to perform the following acts:
providing a first request from a first user to access the resource;
receiving a first gate and a first identifier identifying a first gate client;
determining whether the first gate client is stored locally;
requesting, if the first gate client is not stored locally, the first gate client;
receiving the first gate client;
presenting the first gate using the first gate client; and
providing a first response to the first gate.

12. The system of claim 11, wherein the first request includes first user information.

13. The system of claim 11, wherein the first request includes resource information and first user information.

14. The system of claim 11, wherein the first request includes client cultural information referencing a first client culture and wherein the first gate client is adapted to the first client culture.

15. The system of claim 11, wherein the first identifier comprises a hash value.

16. The system of claim 11, wherein receiving the first gate client includes receiving multiple files that comprise the first gate client.

17. The system of claim 11, wherein the act of receiving the first gate comprises temporarily storing the first gate in the memory, further comprising the act of:
deleting the first gate after providing the first response.

18. A computer readable medium, executable on a computing system, including at least one tangible medium and encoding a computer program of instructions for executing a computer implemented method for determining whether to grant users to access a resource, comprising the steps of:
receiving a first request from a first user to access the resource, wherein the first request includes client cultural information referencing a first client culture;
determining an access policy that is applicable to the first request;
providing a first gate included in the applicable access policy;
providing a first identifier, from a plurality of identifiers, identifying a first gate client, wherein the first gate client corresponds to the first gate and is adapted to the first client culture;
receiving at least a first response from the first user; and
granting the first request if the at least first response satisfies the applicable access policy.

19. The computer readable medium of claim 18, further comprising the steps of:
receiving a request for the first gate client;
providing the first gate client.

20. The computer readable medium of claim 19, further comprising:
validating the first response;
providing, after validation of the first response, a second gate included in the applicable access policy; and
receiving a response to the second gate.
